(19) United States
(12) Patent Application Publication
(10) Pub. No.: US 2011/0037248 A1
(43) Pub. Date: Feb. 17, 2011

(54) In Security Documents

(76) Inventor: Paul Howland, Hampshire (GB)

Correspondence Address: GABLE & GOTWALS, 100 WEST FIFTH STREET, 10TH FLOOR, TULSA, OK, 74103, US

(21) Appl. No.: 12/989,943

(22) PCT Filed: Jun. 3, 2009
(86) PCT No.: PCT/GB2009/001393

§ 371 Date: Oct. 27, 2010

(30) Foreign Application Priority Data
Jun. 4, 2008 (GB) 0810198.2

(51) Int. Cl. B42D 15/00

(52) U.S. Cl. 283/113; 283/57

(57) ABSTRACT

The invention relates to improvements in security documents, and a method for making such security documents. The security document made from a fibrous security substrate comprising at least one watermark and a background wiremark pattern. At least one of the said watermark or watermarks comprises at least one machine detectable pattern and, the at least one machine detectable pattern comprises a series of regularly repeating elements in which the pitch of the elements of the pattern is selected to be different from that of the background wiremark pattern formed in the substrate and lies in the range of (5) to (100) elements per cm.

The invention relates to improvements in security documents, and a method for making such security documents.

Documents of value and means of identification, such as banknotes, passports, identification cards, certificates and the like, are vulnerable to copying or counterfeiting. The increasing availability of colour photocopiers, electronic scanning and other imaging systems, and the improving technical quality of colour photocopiers, has led to an increase in the counterfeiting of such documentation. There is, therefore, a need to continually improve the security features of such documentation to add additional security features or to enhance the perceptions and resistance of simulation to existing features.

Steps have already been taken to introduce optically variable features into such documentation which cannot be reproduced by a photocopier or an electronic scanner. Since the photocopying process typically involves reflecting high energy light onto an original document containing the image to be copied, one solution is to incorporate one or more features into the document which have a different perception in reflected and transmitted light. Examples of such security features include watermarks, embedded security threads, fluorescent pigments and the like.

The use of watermarks is fairly common in many security documents. High security multi-tonal watermarks are typically created using a cylinder mould process and are formed by varying the density of paper fibres so that in some regions the fibres are denser, and in others less dense, than that of the base paper layer which surrounds and separates the denser and less dense regions. When viewed in transmitted light the less dense regions are lighter and the denser regions darker than the base paper, and the contrasts can be seen very clearly. Different types of watermarks have different advantages. A multi-tonal watermark is often a pictorial image, such as a portrait, and can be very detailed and complex which significantly reduces the risk of counterfeiting.

In cylinder-mould papermaking, paper is formed on a partially submerged wire-cloth covered cylinder mould, which rotates in a vat containing a dilute suspension of paper fibres. As the cylinder mould rotates, water is drawn through the wire cloth depositing fibres onto the cylinder surface. When the wire cloth is embossed with a detailed image, the fibres deposit with a lesser or greater thickness on the raised and sunken elements of the embossing to form a fully three-dimensional watermark in the finished paper.

The variation in paper thickness in the final watermark is a result of fibre movement from the raised regions of the embossed mesh to the sunken regions of the embossed mesh as the water is drawn through the wire cloth. The fibre movement, and therefore the tonal variation in the watermark, is governed by the drainage rate and the profile of the embossing. This enables excellent control in the gradation of the watermark pattern, producing a subtle tonal range that is unique to the cylinder mould-made watermark process.

An alternative process for generating watermarks is the electrotype process. In the electrotype process a thin piece of metal, generally in the form of an image or letter, is applied to the wire cloth of the cylinder mould cover, by sewing or welding, creating a significant decrease in drainage and fibre deposition and thereby forming a light watermark in the paper. An electrotype watermark may be lighter than a watermark generated, and produced, by conventional embossing. This electrotyping process is well known in papermaking and has been described in US-B-1901049 and US-B-2009185.

Unfortunately, to overcome these types of security features, some counterfeiters have started to produce so-called composite banknotes. In such composite banknotes, part of a genuine banknote is cut out and replaced by a paper strip or the like enabling the cut out part to be used to produce a further, counterfeit banknote or bill. There is a need, therefore, to detect such composite banknotes and this has been difficult using conventional optical inspection techniques. The difficulty stems from the similarity between the genuine substrate and that used to produce the substitute strips. Although such counterfeits are usually held together with tape and this can be detected, it is difficult to differentiate between tape that is used for counterfeiting and tape that is used to mend a torn note.

One solution to this problem has been described in EP-A-1555139 which proposes the use of a watermark which extends over the full security document and which shows a continuous brightness variation over the full document. Thus, when a strip is cut from an existing banknote that has been provided with such a watermark, the brightness of the watermark no longer varies continuously.

The disadvantage of a watermark applied across the whole note is that it either adds to the material cost of the substrate because the denser parts of the watermark contain more fibre and/or it detracts from the strength of the document because the lighter regions of the watermark represent weak points. For moderately localised watermarks these consideration are of little importance but in the case of an all over watermark they can become a significant concern.

It is therefore an object of the present invention to provide an improved security feature which shows when part of the security document has been removed.

According to the invention there is provided a security document made from a fibrous security substrate comprising a watermark and a background wiremark pattern, said watermark comprising at least one machine detectable pattern, the at least one machine detectable pattern comprising a series of regularly repeating elements in which the pitch of the elements of the pattern is selected to be different from that of the background wiremark pattern formed in the substrate and lies in the range of 5 to 100 elements per cm.

The repeating elements of the watermark are difficult to counterfeit whilst being easily detectable and analysable. The scale of the repeating pattern is preferably sufficiently small to have no detectable impact on the paper strength or the amount of fibre used to form a paper for a given document. Any discontinuity in the repeating elements can be quickly machine detected to identify composite counterfeits. The regular repeating elements provide the watermark with multi-redundancy such that even if the document is damaged due to crumpling and wear a sufficient number of the elements will survive to enable detection of the watermark. This multiredundancy aspect is most beneficial when the pitch of the repeating element is small compared to the size of the discontinuity in the counterfeit document.

Both the watermark and the wire mark are formed during the substrate forming process. This is advantageous as it reduces further processing of the substrate.

One of the main differences between the present invention and EP-A-1555139 is that the present invention does not require a continual brightness variation across the whole document. Instead it uses the periodic repeating structure of the watermark There will be a change in brightness within each repeating unit of the periodic structure but there will be no change on a macro scale over the whole document which is the idea of EP-A-1555139. The requirement of a continual change in brightness means that the watermark must change across the note, which requires tight process control. In the present invention, on the other hand, the watermark comprises a repeat of an identical small unit which does not require the same level of process control. A key advantage of this type of periodic repeating structure is that it can be detected using Fourier transform methods, which leads to the multi-redundancy benefits not applicable to the prior art.

In the present invention the repeating pattern is produced during the substrate forming process by varying the distribution of fibres to produce repeating patterns across a substantial proportion of the document substrate. The support surface, in the form of a wire mesh upon which the paper is formed, will cause paper fibres to distribute themselves in a pattern that reflects the structure of the cloth. Such a structure is known as a wiremark and is a form of watermark. The wiremark on a security document is not in itself useful in the present invention because papers with wiremarks of various patterns are widely available commercially and could therefore be obtained by counterfeiters seeking to use material similar to the document, or part of the document in the case of composite counterfeits, being counterfeited. However in the current invention the security document comprises at least one additional watermark to the background wiremark of the substrate, and this additional watermark is placed in known restricted locations on the secure document. The presence of this additional watermark provides the counterfeiter with a significant challenge.

In one embodiment of the present invention a security document, which comprises a fibrous substrate such as paper, is formed on a permeable support which, may be a wire mesh or cloth, the said wire mesh or cloth comprising two or more regions (one of which is the background region) each with a different permeable support and each chosen so as to produce a different repeating pattern of fibre distribution.

By contrast, three dimensional watermarks produced by the embossing process described above, can not be made with such fine repeating elements as a woven wire mesh. As a consequence they do not have such a high level of built in multi redundancy and are more difficult to analyse using methods such as FFT because they incorporate less statistical data.

In another embodiment of the present invention the watermark can also be produced by forming the paper onto a permeable surface comprising electrotypes as described above. This approach overcomes the limitations of scale suffered by the so called three dimensional watermarks. Electrotype watermarks do however produce simple single tone patterns. As such they are less complex than the patterns produced by wire marks and are therefore easier to replicate using counterfeiting methods.

The fibrous substrate is preferably made from cotton based paper stock but alternatively wood based pulp or synthetic fibres can be used.

A preferred embodiment of the present invention will now be described in detail, by way of example only, with reference to the accompanying drawings, in which:

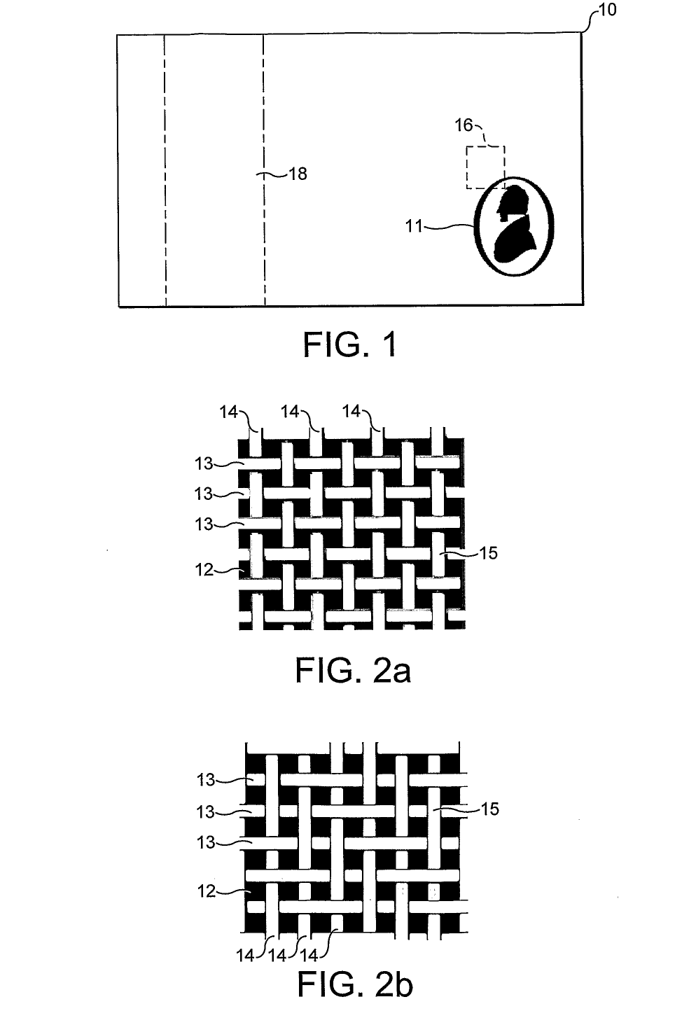

FIG. 1 is a plan view of a security document of the present invention viewed in transmission including two different types of watermark;

FIGS. 2a and 2b are plan views of sections of alternative wire meshes used to form the outer layer of a cylinder mould cover for producing the security document of FIG. 1;

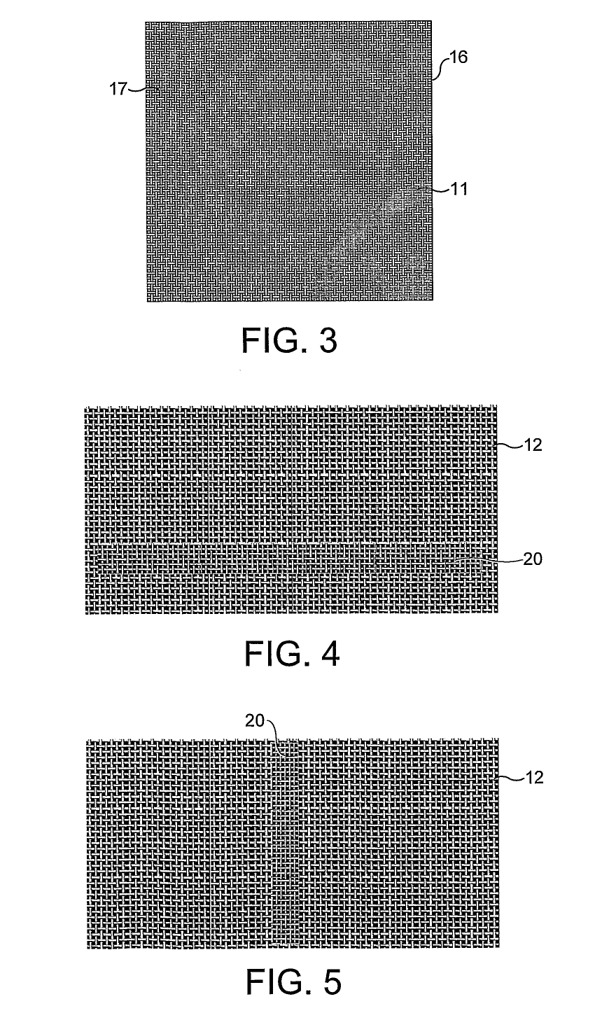

FIG. 3 is a transmission scan of a section of the security document of FIG. 1;

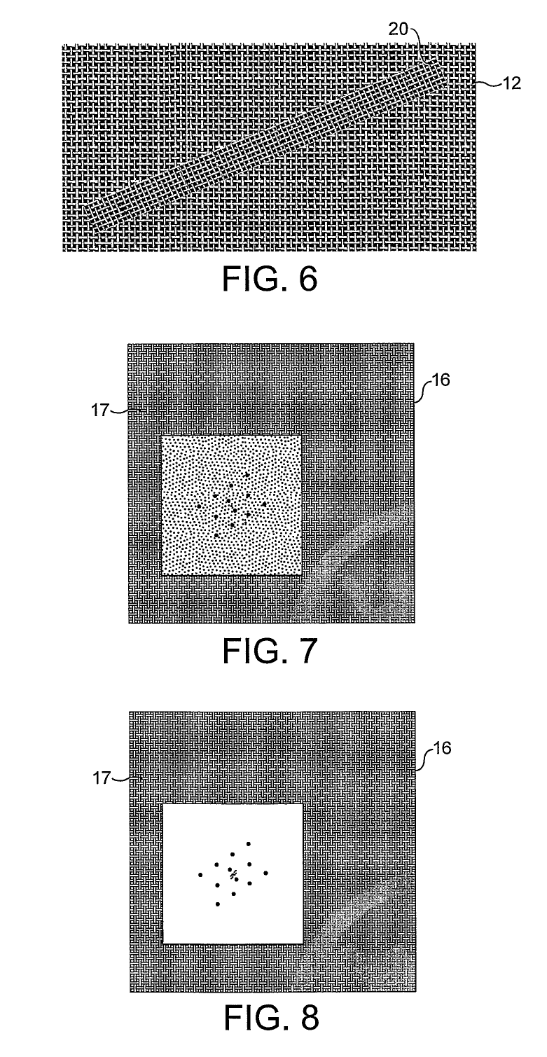

FIGS. 4 to 6 are plan views of further sections of the outer layer of a cylinder mould cover used to form a security document according to the present invention;

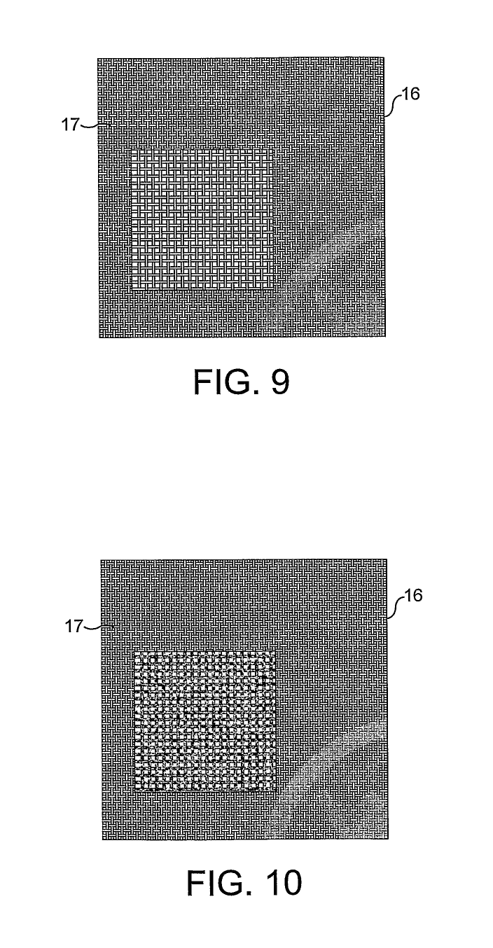

FIGS. 7 to 10 illustrate the different steps used in the Fourier Transform Analysis of a watermark of the present invention;

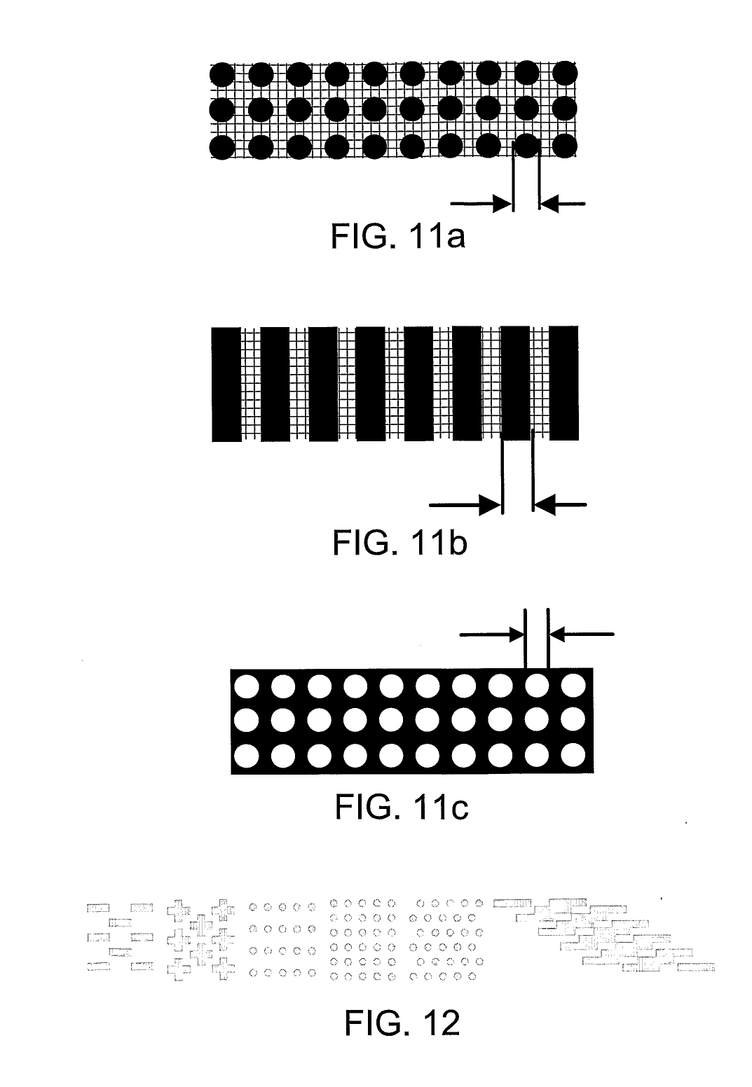

FIGS. 11a, 11b and 11c are sections of the outer layer of a cylinder mould cover with electrotype; and

FIG. 12 shows some examples of suitable repeating patterns for the watermark of the security document of FIG. 1.

Referring to FIG. 1 there is shown a security document 10 according to the present invention made from a substrate, such as paper. The substrate is preferably made using a cylinder mould papermaking machine as described above. Many security documents have a conventional multi-tonal watermark 11, of the type described above, which can be viewed in transmissive light.

The cylinder of the papermaking machine includes a mould cover which provides a support surface on which the substrate is formed. The mould cover generally comprises four layers of wire mesh (cloth), which is typically made of phosphor bronze of which the outer two layers are embossed to form any watermarks 11 required in the substrate. The outermost layer, on which the substrate fibres are deposited and the substrate thus forms, is known as the face cloth and typically has a mesh size of 27 warps per cm by 18 wefts per cm (27/18). FIGS. 2a and 2b show sections of two different constructions of mesh used for the outer layer 12 of the mould cover, namely a simple weave and a twill weave.

When a web of substrate is formed using such a mould cover, the profile of the mesh produces what is known as a “wire mark” across the entire web. Generally, where the warp wires 13 (in the machine direction) and weft wires 14 (in the cross direction) cross, a knuckle 15 is formed which is slightly raised relative to the wires 13,14. The knuckles 15 cause a very minor variation in the density of the substrate fibres which are deposited on the surface of the mould cover. The imprint of the wire mesh also causes a barely perceptible undulation of the surface of the finished substrate and a regular pattern throughout the substrate which is virtually indistinguishable to the unaided eye. However the wire mark 17 created by the multiple knuckles 15 can be detected using suitable aids. FIG. 3 is a transmission scan of a section 16 of the security document 10 of FIG. 1 which shows the regular pattern of the wire mark 17.

In the present invention, a security substrate is used to form a security document 10 which has a watermark 18 which incorporates a machine detectable pattern 19 comprising regularly repeating elements. The watermark 18 is produced in the security substrate such that, when security documents 10 are formed from the substrate, the watermark 18 is preferably present in a limited strip along the full width and/or length of the document 10, but not covering the whole document 10. The strip may also span diagonally across the document 10. The strip may have linear edges, or alternatively may have undulating edges or a variable width. This pattern 19 can be machine detected in transmitted or reflected radiation, distinguished from the wire mark 17 and analysed to ensure that there are no interruptions in the repeating elements of the pattern 19.

The repeating elements of the pattern 19 can be of any form (some examples are shown in FIG. 12), but preferably they repeat in a period of between 5 and 100 per cm and more preferably in a period of between 10 and 50 per cm. The pitch of the repeating elements of the pattern 19 is selected to be comparatively small relative to the section which is likely to be removed in the formation of a counterfeit composite document. The pattern 19 must also either be different from, or have a different period or phase to that of the pattern of the background wire mark 17 created by the main wire mesh.

Preferably the watermark 18 is not readily apparent to the naked eye, without assistance of a magnifying or other aid, either in reflection or in transmission. This is achieved by choosing the scale and contrast of the repeating pattern 19 so as to make it virtually indiscernible from the parts of the document 10 adjacent the feature. The detectable feature may be a variation in opacity, in reflectivity, in mass through the thickness of the document 10 or by surface undulation.

The watermark 18 may be a secondary wire mark produced by attaching a watermark forming section 20 either to the surface of the outer layer of the wire mesh 12 of the mould cover, or in an embossed recess in the outer wire mesh 12. Alternatively the watermark, forming section 20 may be incorporated into the outer layer of the wire mesh 12 of the mould cover by cutting out an area of the outer layer of the wire mesh 12 and inserting the watermark forming section 20 by sewing or welding. In the same manner the watermark forming section can be incorporated into an embossed recess in the outer wire mesh 12. The watermark forming section 20 is preferably in the form of a woven mesh. Examples are shown in FIGS. 4 to 6 of security mark forming sections 20 placed in different orientations on the wire mesh 12. Where the forming section 20 is a mesh, it may be a simple or a twill weave, such as were illustrated for forming the outer wire mesh 12 of the mould cover 1 but it must have a different geometry or alignment to that of the outer wire mesh 12. The mesh of the watermark forming section 20 preferably has a warp pitch in the range of 16 to 50 warps per centimetre and a weft pitch in the same range. The mesh of the watermark forming section 20 may be characterised by specific and optionally different wire diameters, which are preferably in the range of 0.15 mm to 0.25 mm.

The watermark forming section 20 may also be provided by attaching a plurality of metal or other impermeable elements, such as an electrotype, to the wire mesh 12. Where electrotypes are used, the individual drainage restricting elements should have a diameter or width less than 0.5 millimetres, in each of the directions of the pairs of arrows shown in FIGS. 11a to 11c.

The watermark 18 is not limited to those formed on a cylinder mould paper machine and, for example, may be created by using a dandy roll on a Fourdrinier paper machine.

A number of different machine detection methods can be used to detect the pattern 19 of the watermark 18. The method can use transmissive radiation chosen from throughout the electromagnetic spectrum, the preferred options being x-ray, infra-red or visible radiation. The method may also use particle radiation, such as beta radiation. Alternatively the detection method may rely on reflective methods, such as light scatter or light reflection (using infra-red or visible light).

Regularly repeating patterns can be extracted from other background patterns (such as wire marks) or substrate variations in the document using well known computational methods, such as FFT (Fast Fourier Transform), auto or cross-correlation analysis. These methods can be used to identify whether a repeating pattern 19 exists across or along the document 10 and they are able to analyse weakly discernable patterns which are not visible to the naked eye. They are thus able to reveal whether there is any interruption or discontinuity in the repeating pattern 19, which would happen as a result of wear and tear or from illicit tampering of the document 10 resulting from the production of a composite counterfeit document.

Where FFT analysis is used, for example, it enables a portion of the image that has been detected to be analysed by plotting a frequency domain, as shown in FIG. 7. The dominant parts of the frequency domain, which represent the repeating elements of the pattern 19, are extracted by simple image thresholding, as shown in FIG. 8. The frequency domain is then reversed to recreate the image, but as only the repeating elements of the pattern 19 are used, it is the watermark 18 rather than the paper formation that is visualised. This can then be further analysed to quantify the pitch of the elements of the repeating pattern 19 and their dimensions. FIG. 10 shows the watermark 18 subtracted from the original image.

Although the main aim of the invention is to provide a solution to the composite note problem, the pattern 19 of the watermark 18 may also provide useful indicia, such as information which can be used by a denomination sorter. Thus a specific pitch of the pattern 19 could be used for a specific denomination of banknote. Where the watermark 18 is used for this purpose alone, it does not need to extend along the full width or length of the document 10.

Several patterns 19 arranged in adjacent blocks may also be used. The particular combination of block size and pattern type can be used for denomination sorting.

The repeating pattern 19 may also comprise several overlaying patterns, which increase the complexity and make them harder to replicate.

1. A security document made from a fibrous security substrate comprising at least one security mark and a background wiremark pattern, the at least one security mark comprising:
at least one machine detectable pattern which comprises a series of regularly repeating elements in which a pitch of the elements of the pattern is selected to be different from that of the background wiremark pattern formed in the substrate and lies in a range of 5 to 100 elements per cm.

2. The security document as claimed in claim 1 in which the at least one security mark is substantially not visible to a eye of a user.

3. The security document as claimed in claim 1 in which at least one security mark is provided in a strip along a length and/or width of the security document.

4. The security document as claimed in claim 3 in which the strip spans the security document diagonally.

5. The security document as claimed in claim 1 in which a strip has substantially linear edges.

6. The security document as claimed in claim 1 in which the width of a strip has substantially undulating edges.

7. The security document as claimed in claim 1 in which the width of a strip varies along its length.

8. The security document as claimed in claim 1 in which the regularly repeating elements of at least one machine detectable pattern have a pitch in the range of 10 to 50 elements per cm.

9. The security document as claimed in claim 1 in which the machine detectable feature of at least one machine detectable pattern is a variation selected from the group consisting of opacity, reflectivity, mass and surface profile.

10. The security document as claimed in claim 1 in which the security mark is formed by a security mark forming section of a support or transfer surface of a substrate forming machine.

11. The security document as claimed in claim 10 in which the security mark forming section is a section of woven mesh applied to or incorporated in the support or transfer surface.

12. The security document as claimed in claim 10 in which the security mark forming section comprises a plurality of impermeable elements attached to the support surface.

13. The security document as claimed in claim 1 in which the security mark is foamed by an embossing roll.

14. The security document as claimed in claim 1 in which the security mark is formed by pulsating air jets.

15. The security document as claimed in claim 1, the security mark is formed by a laser in the substrate after it has been formed.

16. The security document as claimed in claim 1 in which at least one machine detectable pattern of the security mark includes or forms indicia which can be used to determine a characteristic of the document.

17. The security document as claimed in claim 16 in which the characteristic is the denomination of a banknote.

18. The security document as claimed in claim 1 in which the security mark comprises a plurality of patterns arranged in adjacent blocks.

19. The security document as claimed in claim 1 in which the security mark comprises a plurality of overlaying patterns.

20. A method of checking a security document having a security mark comprising a machine detectable repeating pattern, which comprises a series of regularly repeating elements in which a pitch of the elements of the pattern is selected to be different from that of a background wiremark pattern formed in the substrate and lies in the range of 5 to 100 elements per cm, said method comprising the steps of: detecting the pattern and extracting it from a background wiremark pattern, and analyzing the pattern using a computational method.

21. The method as claimed in claim 20 in which the computational method is selected from the group consisting of Fast Fourier Transform, auto and cross-correlation analysis.

22. The method as claimed in claim 20 in which the method of detecting the pattern uses transmissive radiation.

23. The method as claimed in claim 20 in which the method of detecting the pattern is a reflective method.

24. The method as claimed in claim 20 in which the method of detecting the pattern uses particle radiation.

25. (canceled)

26. (canceled)
